(19) United States
(12) Patent Application Publication
(10) Pub. No.: US 2003/0120608 A1
(43) Pub. Date: Jun. 26, 2003

(54) Secure method for purchasing and payment over a communication network and method for delivering goods anonymously

(76) Inventor: Jorge Pereyra, Montevideo (UY)

Correspondence Address: CURTIS MALLET-PREVOST COLT & MOSLE,LLP, 101 PARK AVENUE, 35TH FLOOR, NEW YORK, NY, 10178, US

(21) Appl. No.: 10/029,896

(22) Filed: Dec. 21, 2001

(51) Int. Cl. H04K 1/00; H04L 9/00; G06F 17/60

(52) U.S. Cl. 705/64

(57) ABSTRACT

A secure system and method for purchasing and payment to be used on a communication network having at least one server site (Merchant) that offers products and/or services for sale, at least one User that engages in electronic commerce with said Merchant and an Agent that acts as an intermediary between Clients and Merchants and as the Client's agent before Merchants. This invention discloses a secure and fraud inhibitor system and method for an Agent for making secure purchases and payments to Merchant on behalf of the User, while making collections to Users independently; and a method and system for delivering said purchases to said Users anonymously.

### BACKGROUND OF THE INVENTION

The Internet is a worldwide communications network linking a large number of computers and computer networks (e.g. private and public). Information is exchanged using a number of common protocols and services including electronic mail, file transfer protocol (FTP services), newsgroups and the like. The Internet includes the World Wide Web (WWW), which is not a network itself, but rather a service maintained on top of Internet by a combination of browsers, server sites and HTML pages, among others.

The WWW allows server computer systems (Servers or Web Sites) and devices (Clients) a User utilizes to access the network, typically any Internet browsing appliance (e.g. personal computer, cellular phone and PDA) to interchange messages (the basic unit of structured information transmitted between two parties over a connection on the network) using the Hypertext Transfer Protocol (HTTP). HTTP is a known application protocol based on a Client Request/Server Response paradigm that provides Clients access to files stored on Servers (which can be in different formats such as text, graphics, images, sound, video, etc.) using a standard page description language known as Hypertext Markup Language (HTML). HTML provides basic document formatting used to define Web Pages and allows the developer to specify “links” to other servers and files.

Use of an HTML-compliant browser (application program used for displaying and viewing Web Pages over the Client) involves specification of a link via the Universal Resource Identifiers or URI (also known as WWW addresses, Universal Document Identifiers or the combination of Uniform Resource Locators (URL) and Names (URN)). As far as HTTP is concerned, Uniform Resource Identifiers identify—via name, location, or any other characteristic—a network resource (Resource).

Upon instructing the Client with the desired Resource, the Client makes an HTTP Request to the Server identified in the link (the Client HTTP Request includes but is not limited to GET and POST methods, which identifies actions to be performed on the Resource identified by the requested URI) the server process the request and sends a Web Page in return. The Client receives the Web page and displays it using the browser.

HTTP requests to be applied to a Resource on some Server may be accomplished via a single connection between the Client and the Server or via intermediaries that are present in the Request/Response chain. There are three common forms of intermediary: proxy or agent, gateway, and tunnel. A proxy is an intermediary program, which acts as both a server and a client for the purpose of making requests on behalf of other clients. Requests are serviced internally or by passing them, with possible translation, on to other servers. A proxy must interpret and, if necessary, rewrite a request message before forwarding it.

HTTP was designed to interchange specific messages between Client and Server without the user's knowledge. This can include for example, the user's e-mail address, the last web site he came from, and information about the user's software and host-computer. Other pertinent user information may be sent by the web-site to the User browser using what are commonly referred to as “cookies” (information that web-sites may store at the user's browser that provides an easy mechanism to keep session information, such as the contents of a “shopping cart,” account name, password, event counters, user preferences, among others). On subsequent visits to the web site, the user's browser sends back information to the web site without the user's knowledge.

The continued growth of the online retail market is a result of the boom in the online population coupled with the increase number of off-line vendors that are establishing a strong presence online. E-marketer predicts that the US business to consumer (B2C) e-commerce revenues will grow from $38.3 billion in 2000 to $54.2 billion in 2001.

A Merchant can be any vendor who has Internet connectivity and offers different products and/or services (collectively, “Products”) for sale. A customer can be anyone who subscribes to the Internet and browses the vendor web sites for Products. There are well known e-commerce web sites (Merchants) selling different Products over the web; as an example consider stock traders (e.g. www.datek.com), books stores (www.amazon.com), software vendors (e.g., www.microsoft.com) and news (www.cnn.com).

To sell Products over the Web and to deliver said Products to the User, the Merchant requires the User to submit personal information online, including but not limited to user's name and password, email, billing address, shipping address and a payment method (e.g. credit card number) valid for said Merchant to accept online purchases. The Merchant creates a User's account for said User, stores the User's personal information in the Server and uses the information stored in the User's account as a link to the User. The information stored in this User's account is used by the Merchant to send any further communication to the User or other parties that the Server may consider, including but not limited to electronic mails (e-mails), order's delivery confirmation message, delivery instructions. Since this is sensitive information, both vendors and purchasers want to ensure the security of such information. Security is a concern because it may be stolen from the Merchant Server or may be intercepted during transmission. To protect this information, various encryption techniques (e.g. Secure Sockets Layer or SSL, Secure Electronic Transaction or SET) are used when transmitting data over the Internet. Nevertheless, there is always a possibility that an interceptor may successfully decrypt such sensitive information. According to the Consumer Market Survey, more than 66% of computer users are concerned about Internet privacy issues and avoid sites that do not guarantee their security for personal data. The National Consumers League (NCL) found that in 1998 the 67% of Internet Users trusted companies to somewhat follow privacy policies compare to 91% in 2000. As a result, online privacy and security are the most important issues for Internet users and has become a deal breaker for online shoppers.

A survey by Yankelovich Partners finds that 90% of consumers said that the most important issue is protection of privacy of personal information and that 79% leaves websites when they require personal information to proceed. And according to the NCL, loss of privacy ranks as a greater concern to US consumers than healthcare, crime, or taxes. Among Internet users, not only are privacy fears shared by the majority, but they have grown more severe over the past 2 years. The survey also shows that 88% wants to protect their credit card, 85% their social security number and 61% are worried about contact information.

Consumers also identified many “compromises” or barriers to shopping online. Among both new and experienced Internet consumers, experience anxiety over credit card security and privacy or fear to disclose personal information online were the main barrier to purchasing online (emarketer 2000). The Internet Fraud and Compliant Center found an average monetary loss to Internet fraud per victim of $665 and according to the Wall Street Journal report published in October of 2000, 8 out of 10 online shopping carts aren't sold because of fear of releasing private information over the Internet. The Federal Trade Commission (FTC) estimates that consumer fears resulted in estimated online sales losses of $2.8 BB in 1999—a figure that is expected to rise to $18 BB in 2002.

Additionally, online fraud concerns both Users and online merchants. On the merchant side, credit card fraud is viewed as the No. 1 concern by market research firms such as Gartner Group. According to the Wall Street Journal 83% of merchants consider on-line fraud a major obstacle to e-commerce. Online merchants must absorb all charge-back costs as much as four times more than physical world costs and need to pay for fraud protection using transaction-risk scoring services. Many online merchants struggle to find affordable fraud-protection software or services alternatives, which are not 100% reliable and are useless in case of stolen data bases where sensible information like personal data and/or credit cards numbers are stored and can be used latter.

Electronic payment systems can be on-line or off-line. Parties involved in an off-line system, exchange funds without any communication with a third party (e.g. bank); the electronic payment is finished only when the bank receives the funds exchanges, process those exchanges and updates its database.

Parties involved in an on-line system are connected through a Payment Processor over an Authorization Network (private or public) and communicate with this Payment Processor during the course of the transaction. The Payment Processor may initiate funds transfers between both parties and will record the transaction in its databases.

To make collections, online Merchants rely on a variety of electronic payment systems including but not limited to credit cards and electronic checks.

In an embodiment where the Internet is considered, an on-line electronic payment system based on the credit card (Online Credit card Payment) model benefit from the easy of use, familiarity and brand recognition that Payment Processors (e.g. VISA or Master Card) have built up for decades. In case of electronic checks, users that have a checking account may buy on the Internet without needing a credit card, consumers can make a variety of different payments using a single interface that gathers all transactions into a single account log and, finally, the user needs to deal only with his bank instead of other financial institutions.

The Online Credit card Payment system requires commercial (fees, commissions, etc.) and technical (authorization procedures, etc.) agreements between Payment Processor, Issuer and Merchants, among others (discussions concerning other parties involved in an online credit card transaction are beyond the scope of this document). As part of said agreements, the Payment Processor will assign the Issuer a unique identifier. This unique identifier is used by the Issuer to issue payment methods (e.g. credit cards) to its customers. In an embodiment where credit cards are considered, the credit card number uniquely identifies the type of card, the Issuer, and the cardholder's account; in an embodiment where checks are considered; the check number uniquely identifies the issuer and customer.

When a User makes a purchase from a Merchant and uses a credit card as the payment method, the Merchant sends a message over the Authorization Network to the Payment Processor requesting payment authorization for said purchase. The message includes but is not limited to credit card number and expiration date, Merchant's identifier, purchase amount, transaction code and transaction date. The Merchant puts on hold the purchase until the payment authorization is obtained. After processing the transaction, the Payment Processor routes an authorization request to the Issuer of the credit card involved in the transaction, through said Authorization Network. The Issuer verifies the line credit for said credit card and accepts or denies the payment authorization request and generates an authorization code. The Issuer sends back the authorization code to Payment Processor and puts a hold on the cardholder's account for the amount of the purchase. Based on the Issuer authorization code and on the Merchant's identifier, the Payment Processor routes back to the Merchant the approval or deny code. Finally the Merchant system based on the authorization response will accept or deny the purchase transaction to the buyer.

In an embodiment where the Internet is considered, the electronic check system requires a User that makes purchases from a Merchant, an issuer bank (Payment Processor) that issues electronic checks to be used by the User and a bank account for said User. The electronic check functions as a message to the sender's bank to transfer finds. The message includes but is not limited to User's account number, Merchant's identifier, purchase amount, transaction code and transaction date. This message is given initially to the Merchant who, in turn, endorses the check and presents it to the issuer bank to obtain funds.

Business to consumer (B2C) e-commerce's potential is limited by the heavy reliance on major international credit-card networks. Merchants cannot process every existing credit-card transaction and usually subscribe commercial agreements only with major international networks (e.g. VISA and Master Card). Merchants that do not possess those international credit cards either have a very difficult time making payment for the transactions or may not be able to make purchases at all. On the other side, Users that not have access to international credit cards (e.g. local credit cards and debit card users) are also limited to make purchases online, thus limiting the Merchants' potential market.

Finally, international cross-border is a major problem for B2C e-commerce development, especially when dealing with different customs rules and cultures for each country. For delivering Products to the User, the Merchant needs to know, among others, the user name, billing address and shipping address, making the delivery process not anonymous.

The good news is that several solutions have surfaced to provide anonymous browsing, including installable applications which eliminate “cookies” and proxy-servers (Agents) such as Anonymizer (www.anonymizer.com) which provides anonymous surfing; but still these Agents do not provide a secure and fraud inhibitor method and system for making purchases and payments to Merchants on behalf of the User, neither a method for implementing anonymous delivery to Users.

The disclosures of the above publications and of the publications cited therein are hereby incorporated by reference. The disclosures of all publications mentioned in this specification and of the publications cited therein are hereby incorporated by reference.

### BRIEF SUMMARY OF THE INVENTION

The present invention (Solution) address four of the critical issues facing commerce over communication networks from Users, Merchants and Payment Processors perspectives: (a) purchasing and payment privacy and security, (b) commerce limitations due to restricted online payment options, (c) online fraud, and (d) delivery privacy.

To that end the Solution implements a secure and fraud inhibitor method and system for making purchases and payments to Merchants on behalf of the User and a method and system for delivering said purchases anonymously. The Solution operates over an Agent.

The secure and fraud inhibitor purchase and payment method and system splits the User's purchase request in two process and manages and controls those process independently: (a) the Purchase process and (b) the Payment Authorization process.

During the Purchase process, the Solution may authorize the user's payment or may request said authorization to third parties. The total amount that the user needs to pay to the Solution includes the amount of the purchase and others fees (e.g. shipping & handling) or commissions that the Solution may consider, among others. The User can use any payment method supported by the Solution including but not limited to proprietary credit cards, debit cards, checking accounts and prepayment; or can use other payment methods supported by the Solution in partnership with other institutions which act as the User's Payment Processor, including but not limited to local, regional and/or international Issuers, telecommunication companies and banks, thus extending the User's online payment methods. In this case, the User's Payment Processor manages all the payment information (e.g. credit cards) related with said User, process the authorization request received from the Solution and informs the Solution (e.g. sends an electronic message, makes a phone call, etc.) of the user's payment authorization response and the payment authorization code. Whichever be the case, the User's information is safeguarded by the Solution and is never disclosed to the Merchant, thus protecting the Users privacy and security. Additionally, the Solution may implement different payment plans, including but not limited to paying in quotes and/or financial plans. This combination of new online payment methods with new online payment plans, dramatically expands the users purchasing power on the Internet while opening new markets to Merchants. After charging the User for the purchase, the Solution submits the User's purchase to the Merchant on behalf of the User. To submit said purchase, the Solution uses a valid payment method (e.g. credit card) and a Solution's Account for said Merchant.

Once the user's payment authorization has being approved either by the Solution or its partners, the Solution submits the purchase to the Merchant using the Solution's Account for said Merchant and for said User. The Merchant processes the purchase request and updates various databases. Prior to delivery of goods to the buyer and based on the payment method identifier (e.g. credit card number) which unique identifies the Payment Processor, the Merchant server sends a message over the Authorization Network to the Payment Processor requesting Payment Authorization of said purchase. The message includes but it is not limited to payment method identifier, transaction date, Merchant's identifier and purchase amount. The Merchant puts the purchase on hold until the payment authorization is obtained.

The Payment Authorization process implemented in this invention is designed to authorize payments only for transactions that the Solution has submitted, acting as a fraud transactions inhibitor for both online and/or physical transactions, thus increasing security levels and reducing fraud. To that end we envision the Payment Authorization process as an authorization method that approves or denies the payment authorization requested for all transactions submitted with a payment method managed and controlled by the Solution. This way, even if payment methods used by the Solution to submit purchases to Merchants are stolen or used by non-authorized parties, no electronic or physical purchases that requires payment authorization, submitted with said stolen payment methods will be authorized, thus acting as a shield for both online and physical fraud transactions. To that end, the Payment Authorization process validates the ownership of the purchase that its being requested for payment authorization, prior to authorizing the payment to said Merchant. This way, the Solution assures that the transaction that is being requested for authorization from the Merchant was submitted by the Solution, in such cases said authorization is approved, in other cases the authorization is denied by the Solution. The Payment Authorization process can be either Online or Offline; in the Online Payment Authorization Method, the Solution validates the ownership of the purchase; in the Offline Payment Authorization Method the Issuer of the payment method used to submit said purchase validates the ownership of said purchase based on instructions previously notified by the Solution.

The Solution also manages the Merchant's registration process on behalf of the User through a Solution's Account for said Merchant. During the User's account registration process for said Merchant, or when the Solution deems appropriate, the Solution computes and submits the information required by the Merchant for said registration process including but not limited to user's alias name, user's alias password, user's alias email, user's alias shipping address, user's alias billing address and user's alias payment method (e.g. the credit card number used by the Solution to submit purchases to Merchant), thus creating an Alias account for said User on said Merchant. The Solution may also create an Alias Verification Code that may be included as part of the Alias account an may be used later during the Payment Authorization process.

Alias accounts are used by the Solution to (a) submit online purchase to Merchants and (b) protect the User's privacy because it the only party that can establish the link between a User and its associated Alias account. Alias accounts may be assigned by the Solution in a one (Alias) to one (User) relation or in a one (Alias) to many (Users) relation, whichever the Solution considers appropriate. In an embodiment where the Solution defines a one (Alias) to many (Users) relation to a specific Merchant, the Solution will canalized all the purchases of said Users on said Merchant through the specific Alias. For example, if the Merchant delivers discounts orders, said discount orders are notified to the Solution through the Alias account. In an embodiment where the Solution wants to keep a one (Alias) to one (User) relation, one Alias account will be defined for each combination of User and Merchant. This way, the Solution will use the Alias account assigned to a specific User to make purchases on behalf of said User.

The Solution may control the Alias session (e.g. cookies) identification for each Merchant. This way the Solution manages (creates, modifies and/or deletes) a special session for each combination of Merchant and Alias account. When a User requires a connection to a Merchant, the Solution establishes a session for the Alias account assigned to the User with said Merchant. This allows the Merchant to identify the User unmistakably through the Solution, regardless of the device being used by the User (e.g. Computer) to be connected to the Solution.

The delivery method and system divides the delivery process in two steps: (i) from Merchant to Solution's Delivery Agent and (ii) from Solution's Delivery Agent to User, thus protecting the User's Identity to Merchant. When the Merchant confirms to the Solution (the buyer) the delivery of the order, it communicates to the Solution the Order's Unique Identifier and the order details; the Solution sends a message to the Solution's Delivery Agent notifying the Order's Unique Identifier, the order details and the instructions to deliver said order to the User. This instructions includes but is not limited to user's name, user's shipping address and billing address and may request to the Solution's Delivery Agent to repackage the order and/or consolidates the order with other orders prior to deliver to the User. Once the Delivery Agent receives the order package from the Merchant, it processes the order in accordance to the instructions received from the Solution and ships it to the User.

To use the Solution the User no needs to download any software nor configure the Client. Additionally the Solution may operate without any agreements or relations with Merchants (e.g. business and/or financial agreements, development of technological, operational and/or technical solutions).

The Solution needs an agreement with an Issuer to implement the Payment Authorization process. In such agreement, the Issuer issues (physical or virtual) payment method (e.g. credit cards and electronic checks) to be used only by the Solution. Additionally, the Solution and the Issuer implements a procedure in which the Issuer requests the Solution to authorize the payment to every authorization request that the Issuer receives and that it's associated to a payment method that the Issuer has agreed to be used only by the Solution (in some cases the Solution may request the Issuer to validate said authorization request based on instructions previously defined by the Solution). This way, even if the payment methods (e.g. credit cards and electronic checks) used by the Solution to submit purchases to Merchants are stolen, no electronic or physical purchases that requires payment authorization, submitted with said stolen payment methods will be authorized, thus acting as a shield for both online and physical fraud transactions.

The purchase ownership validation made by the Solution is guaranteed because the Transaction Details (including but not limited to payment method, transaction date, Merchant's identifier and purchase amount) are used in the validation process. When the Merchant requires the Payment Authorization for said purchase, the Transaction Details are informed from the Merchant to Payment Processor, from the Payment Processor to the Issuer and, finally, from the Issuer to the Solution. Once the Solution receives from the Issuer the Payment Authorization request, the Solution validates the purchase ownership by comparing the Transaction Details with the data stored in its databases.

Depending on the Authorization Network used to carry the Payment Authorization request from Merchant to Solution described above, the ownership validation process can be implemented using other pieces of information in addition and/or substitution of the Transaction Details. Consider for example an Authorization Network that sends as part of the Transaction Details, not only the credit card number and expiration date, transaction date, Merchant's identifier and purchase amount, but also the name of the credit card holder. In this case the Solution defines a unique Alias Verification Code for the Alias account and assign said Alias Verification Code to the name of the credit card holder during the Alias registration process. This way, when the Merchant requires a Payment Authorization, the name of the credit card holder or the Alias Verification Code will be part of said authorization request. This way the Alias Verification Code is informed by the Merchant to the Solution as part of the Payment Authorization process, and the Alias Verification Code will be used by the Solution to verifying the ownership of the purchase transaction. This method may be used when the Solution uses only one credit card to make all purchases, regardless of the Users that requires said purchases.

### BRIEF DESCRIPTION OF THE DRAWINGS

FIG. 1 is a flowchart of the steps involved to establish a session between the Solution's Server and the User.

FIG. 2 is a flowchart of the steps involved to establish the Solution's Server as a proxy between the User and the Merchant that the User wants to browse.

FIGS. 3A, 3B, 3C, 3D and 3E are flowcharts of the steps involved during a purchase transaction in a Merchant.

FIG. 4 is a block diagram of the Online Payment Authorization Method consistent with the invention.

FIG. 5 is a flowchart of the steps involved in a Online Payment Authorization to a specific Merchant in accordance with the implementation in FIG. 4.

FIG. 6 is a block diagram of the Offline Payment Authorization Method consistent with the invention.

FIG. 7 is a flowchart of the steps involved in an Offline Payment Authorization to a specific Merchant in accordance with the implementation in FIG. 6.

FIG. 8 is a flowchart of the steps involved in the delivery process.

### DETAILED DESCRIPTION

In an embodiment where the Internet is considered, the present invention operates as follows:

It should be noted that the term “sanitized” as used herein, means a process executed by the Solution's Server for identifying, modifying and/or substituting any portions of a message (e.g. user's requests, pages, electronic mails, etc.) that the Solution's Server deems appropriate, specially those that may compromise the User's identity; this may include but is not limited to (a) redirecting links to data on the Merchant's own servers or other third-party servers to a cached copy of the data on the Solution's Server (b) completing forms data fields with data computed and provided by the Solution's Server or with data that was previously provided by the User—either as part of the Solution's Server registration procedure or previous actions—, (c) adding, modifying and/or erasing content embedded in a page or electronic mails, among others and (d) replying to actions—e.g. request page—requested by Client to Merchant or by Merchant to Client, with new actions—e.g. other page defined by the Solution's Server instead of the page being requested—defined by the Solution's Server substituting and/or blocking the original action).

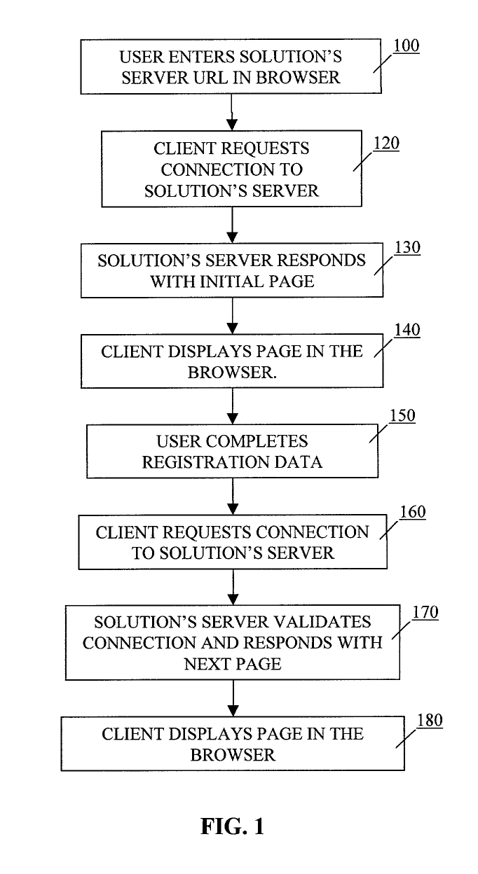

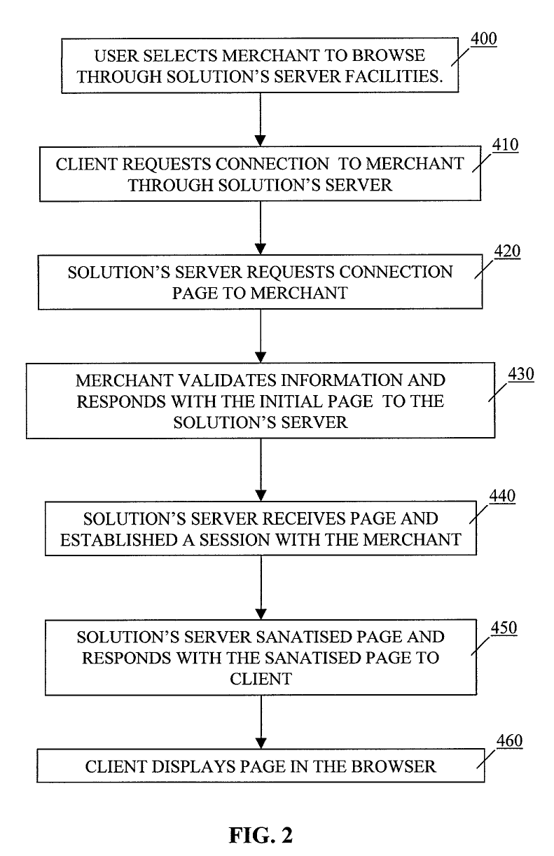

FIG. 1 is a flowchart of the steps involved to establish a session between the Solution's Server and the User. The User enters the Solution's Server 10 URL in the browser (step 100). The Client 70 requests connection to the Solution's Server 10 (120). The Solution's Server 10 receives the connection request and responds with the initial page (or similar Page) to the Client 70 (step 130). The Client 70 displays the initial page in the Browser (step 140). The User completes the information required in the initial page (e.g. to log on to the Solution's Server the User may enter the User ID and password or other information required by the Solution's Server) (step 150). The Client 70 requests the User's registration data to the Solution's Server 10 (step 160). The Solution's Server 10 validates the data, responds to the Client 70 with the next page and established a session between the Client 70 and the Solution's Server 10 (step 170). The Client 70 displays the page in the browser (step 180).

FIG. 2 is a flowchart of the steps involved to establish the Solution's Server (Solution's Server 10) as a proxy between the User and the Merchant 40 that the User wants to browse. The User chooses the Merchant 40 to browse, either by entering its name or address (e.g. www.amazon.com, www.yahoo.com/news.html) on the Address Window, or selecting it from a directory on the Solution's Server 10 (step 400). The Client 70 requests the connection to selected Merchant 40 through the Solution's Server 10 (step 410). The Solution's Server 10 requests the initial page to Merchant 40 (step 420). The Merchant 40 receives the Solution's Server 10 request, process and validates the information submitted by the Solution's Server 10 and sends the requested page, the requested page may be customized for the User by the Merchant 40, e.g. cookies (step 430). The Solution's Server 10 receives the Merchant 40's page thus establishing a session to the Merchant 40 for said User. The Solution's Server 10 receives and processes the page and generates a Sanitized Initial page; the Solution's Server 10 responds to the Client 70 with the Sanitized Initial page (step 450). The Client 70 receives and displays the page in the Browser, thus connecting the User to the Merchant 40 through the Solution's Server 10 (step 460); this effectively establishes the Solution's Server 10 as a Proxy between the User and the Merchant 40, in which all messages (e.g. pages, etc.) are Sanitized by the Solution's Server 10 and relayed between the User and the Merchant 40. Now the User can browse and/or buy on the Merchant 40 through the Solution's Server 10 anonymously.

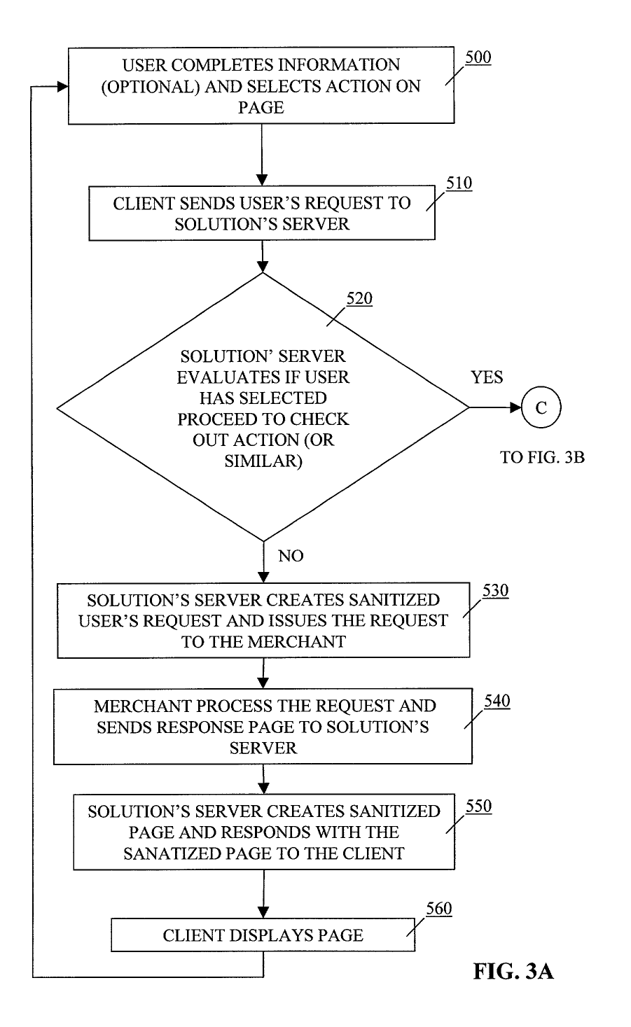

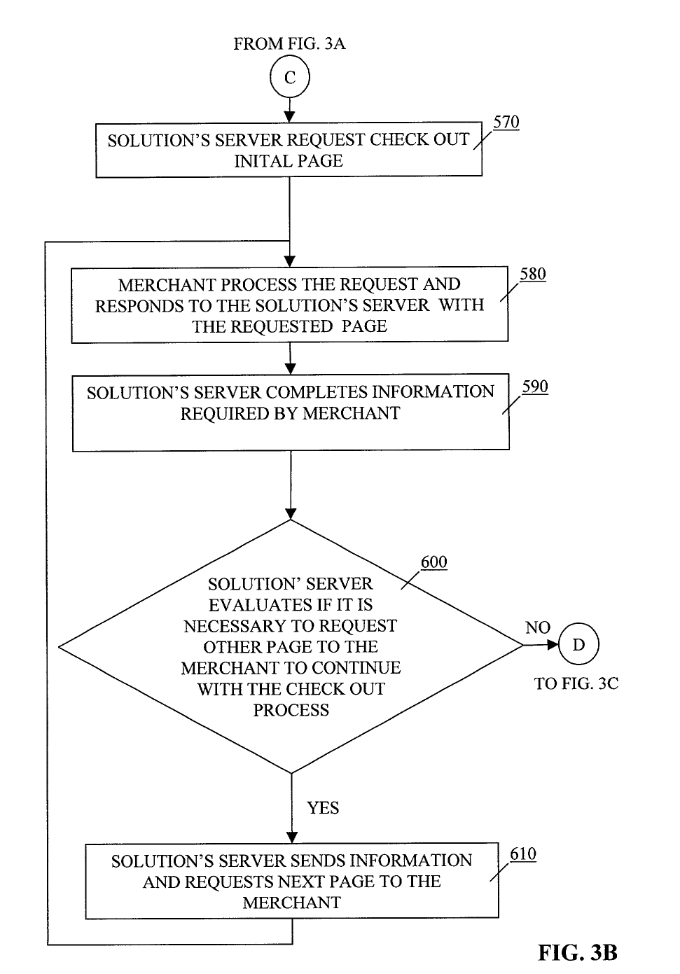

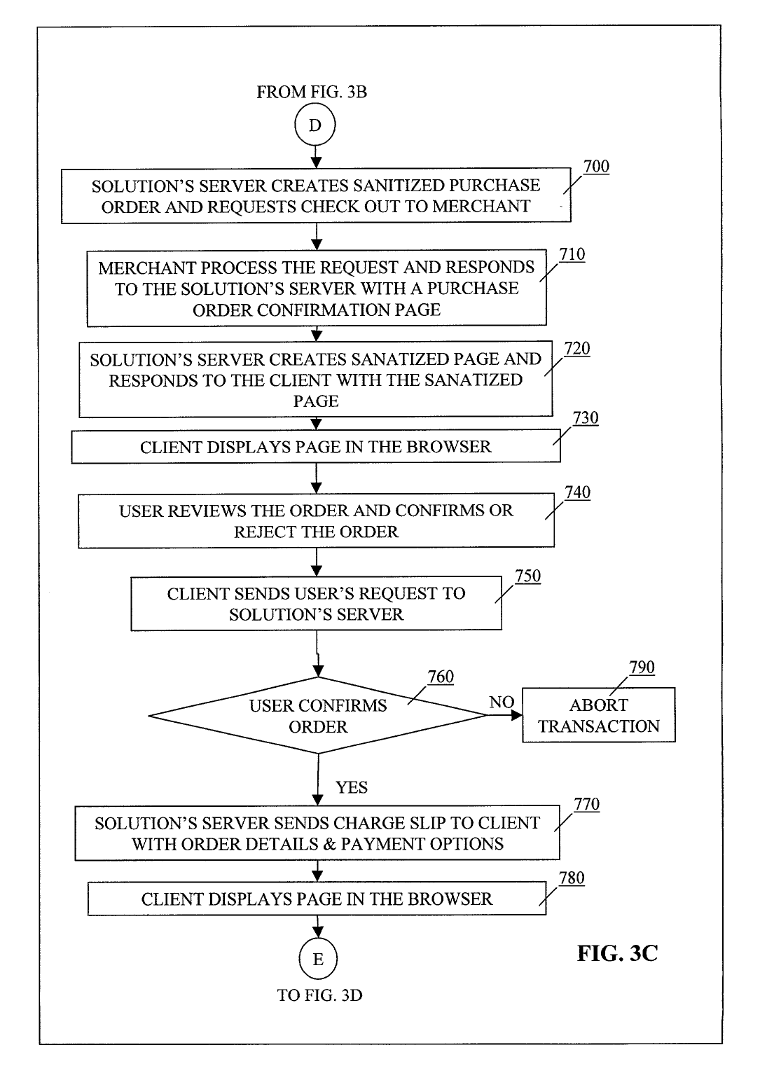

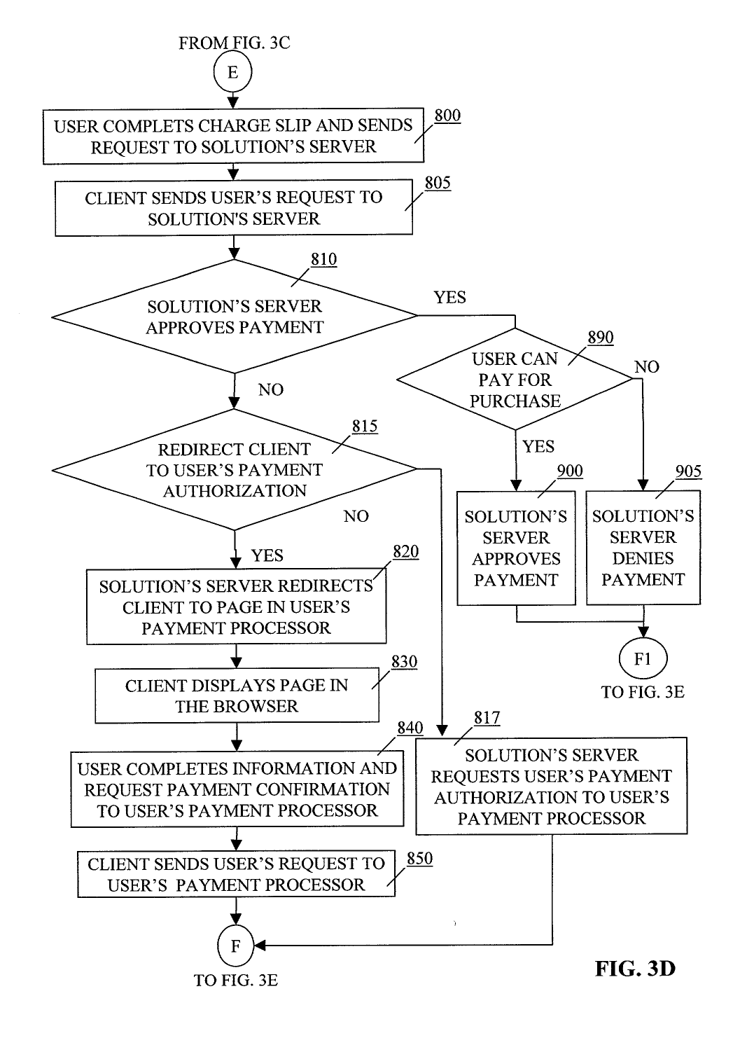

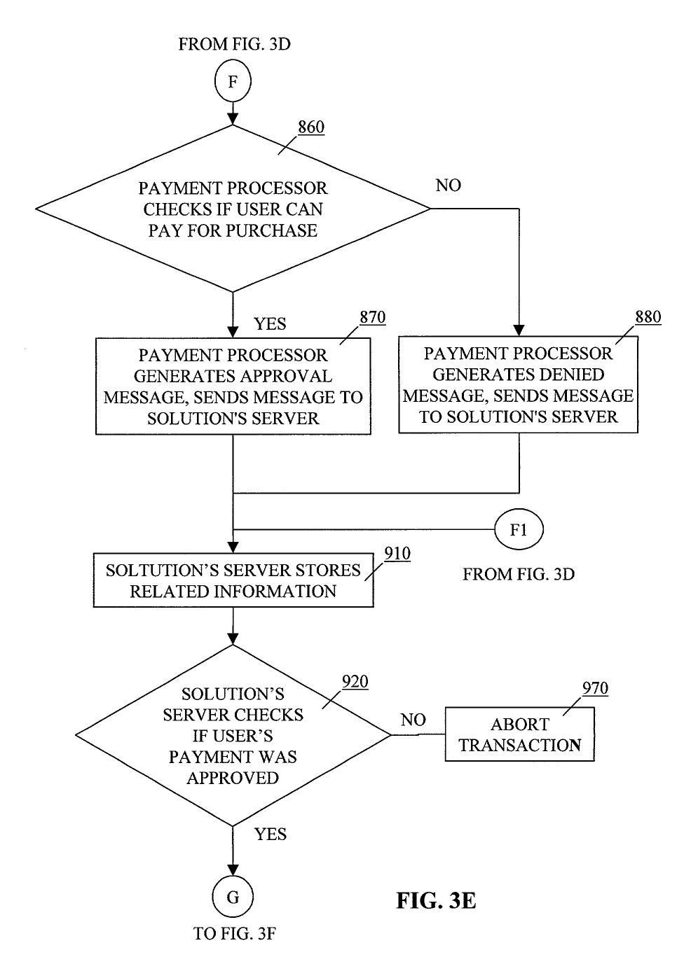

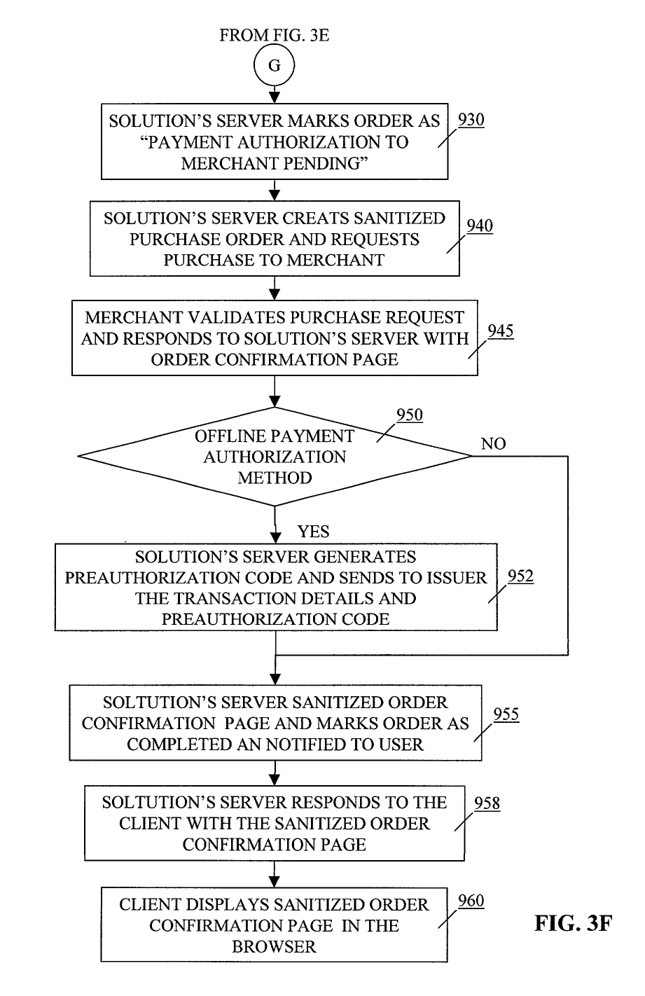

FIGS. 3A to 3F is a flowchart of the steps involved during a purchase transaction in a Merchant 40. The User completes information (optional) and selects action on the page of the Merchant 40; in an embodiment in which the User is browsing through an electronic catalog, the User may begin adding items to a virtual “shopping cart”; though the specific actions required to add items to an order may be quite different depending on the Merchant 40, the process essentially involves the User selecting an action, such as clicking on a button on the page, that requests information from the Merchant 40 on a specific item (step 500). The Client 70 sends the user's request to the Solution's Server 10 (step 510). The Solution's Server 10 evaluates the action that the User has chosen; in case the User has finished adding items to the order (the User indicates that the selection or order is complete by launching the “Check-Out Process” usually found on a page involved in the purchase process; though specific processes differs depending on the Merchant 40, it generally involves a specific action such as clicking a “check-out”, “buy” or “done” button or other actions like making a specific sound, touching a specific part of the Client 70 screen, etc.) the process continues on step 570 (step 520), in other case the Solution's Server 10 processes the user's request and generates a Sanitized User's Request; the Sanitized User's Request is then requested to the Merchant 40 by the Solution's Server 10 (step 530). The Merchant 40 processes the request and responds to the Solution's Server 10 with the required page (step 540). The Solution's Server 10 receives and processes the page and generates a Sanitized Response page; the Solution's Server 10 responds to the Client 70 with the Sanitized Response page (step 550). The Client 70 receives and displays the Sanitized Response page in the Browser (step 560), thus initiating the step 500 once again. When the user selects the Proceed to Check Out action, the Solution's Server 10 request to the Merchant 40 the Check Out Initial page (step 570), thus initiating the check out process. The Merchant 40 processes the request and responds to the Solution's Server 10 with the requested page (step 580). The Solution's Server 10 completes the information required by the Merchant 40 (step 590). The Solution's Server 10 evaluates if it is necessary to request to the Merchant 40 other page to continue with the check out process (step 600). If the Solution's Server 10 needs to request another page to continue with the check out process, the Solution's Server 10 sends the information completed in step 590 and requests the next page to the Merchant 40 (step 610), thus initiating step 580 once again. In another case the Solution's Server 10 generates a Sanitized Purchase Order page; the Sanitized Purchase Order Page is then requested by the Solution's Server 10 to the Merchant 40 (step 700), thus submitting the purchase order to the Merchant 40. The Merchant 40 processes the Solution's Server 10 request and responds to the Solution's Server 10 with a Purchase Order Confirmation page (step 710). The Solution's Server 10 generates a Sanitized Purchase Order Confirmation Page and responds to the Client 70 with said Sanitized Purchase Order Confirmation page (step 720). The Client 70 displays the Sanitized Purchase Order Confirmation page in the browser (step 730). The User reviews the order items and quantities, amounts, billing address, delivery address, among others and confirms or rejects the Order (step 740). The Client 70 sends the User's request to the Solution's Server 10 (step 750). The Solution's Server 10 evaluates that the User has confirmed or rejected the Order (step 760). If the User chooses not to confirm the order, the Solution's Server 10 aborts the transaction (step 790). If the User confirmed the order, the Solution's Server 10 validates the transaction data and stores relevant information associated with the order; the Solution's Server 10 redirects the Client 70 to a secure page on the Solution's Server 10 which displays a Charge Slip for the Order; this Charge Slip includes any information required by the User to unique identify the purchase (items, amounts, etc.), the User's payment options, shipping and handling costs, billing and shipping address, among others (step 770). The Client 70 displays the Charge Slip in the browser (step 780). The User completes the Charge Slip with the information required to continue with the Order, including but not limited to payment method, billing options, special financing plans or payment plans (e.g. quotes), delivery options, Merchant promotions and/or discounts; the User may use the default payment method as defined in the User Profile or select any of the Payment Methods supported by the Operator; and selects action on the page (step 800). The Client 70 sends the User's request to the Solution's Server 10 (step 805). The Solution's Server 10, based on the information submitted by the User, evaluates if the payment authorization for said purchase needs to be requested to a third party or may be authorized by the Solution's Server 10 (step 810). In case the User's payment authorization needs to be processed by the Solution's Server 10, the Solution's Server 10 checks if the User can pay for said purchase (e.g. enough credit limit, enough money in his checking account or prepayment account) (step 890) and approves the payment if the User can pay for the purchase (step 900) or, in other case, denies the payment (step 905); either case the process continues in step 910. In case the user's payment authorization needs to be processed by a third party, the Solution's Server 10 evaluates if the user's payment authorization needs to be requested to the User's Payment Processor directly from the Solution's Server or needs to be requested by the User (step 815); if the user's payment authorization needs to be requested directly from the Solution's Server to the User's Payment Processor without the User's participation, the Solution's Server requests the user's payment authorization to the User's Payment Processor and this process continues on step 860 (step 817); if the user's payment authorization needs to be requested by the User to the User's Payment Processor, the Solution's Server 10 redirects the Client 70 to a predefined page in the User's Payment Processor 60 (step 820). The Client 70 displays the User's Payment Processor 60 page in the browser (step 830). The User completes any information required by the User's Payment Processor and requests the payment confirmation to the Payment Processor (step 840). The Client 70 sends the User's request to the User's Payment Processor 60 (step 850). The User's Payment Processor 60 checks if the User can pay for said purchase (e.g. enough credit limit, enough money in his checking account or prepayment account) (step 860); if the User can pay for the purchase, the User's Payment Processor 60 generates an approval message and sends said approval message to the Solution's Server 10 (step 870) or, in other case, the User's Payment Processor 60 generates a denied message and sends said denied message to the Solution's Server 10 (step 880); either case the process continues in step 910. The Solution's Server 10 records the transaction and the user's authorization payment details (step 910). The Solution's Server 10 checks if the user's payment has being approved (step 920); if User's payment has being denied, the Solution's Server 10 sends a message to the User and aborts the transaction (step 970); if User's payment has being approved, the Solution's Server 10 marks the order as “Payment Authorization to Merchant Pending” (step 930). The Solution's Server 10 generates a Sanitized Purchase Order page and submits the purchase order to the Merchant 40 using said Sanitized Purchase Order page (step 940). The Merchant 40 validates the purchase request and responds to the Solution's Server 10 with the Order Confirmation page (step 945). Solution's Server 10 evaluates if it needs to apply Online Payment Authorization or Offline Payment Authorization method for said purchase (step 950). If Solution's Server 10 needs to apply the Offline Payment Authorization method for said purchase, the Solution's Server 10 generates a Pre-authorization Payment Code for said purchase, sends to the Issuer 20 the Pre-authorization Payment Code and the Transaction Details, including but not limited to the payment method, Merchant's 40 Identifier, purchase amount and transaction date, and stores in its database the Pre-authorization Payment Code and Transaction Details (step 952). The Solution's Server 10 receives and Sanitized the Order Confirmation page and marks the order as “Completed and Notified to User” (step 955). The Solution's Server 10 responds to the Client 70 with the Sanitized Order Confirmation page (step 958). The Client 70 displays the Sanitized Order Confirmation page in the browser (step 960).

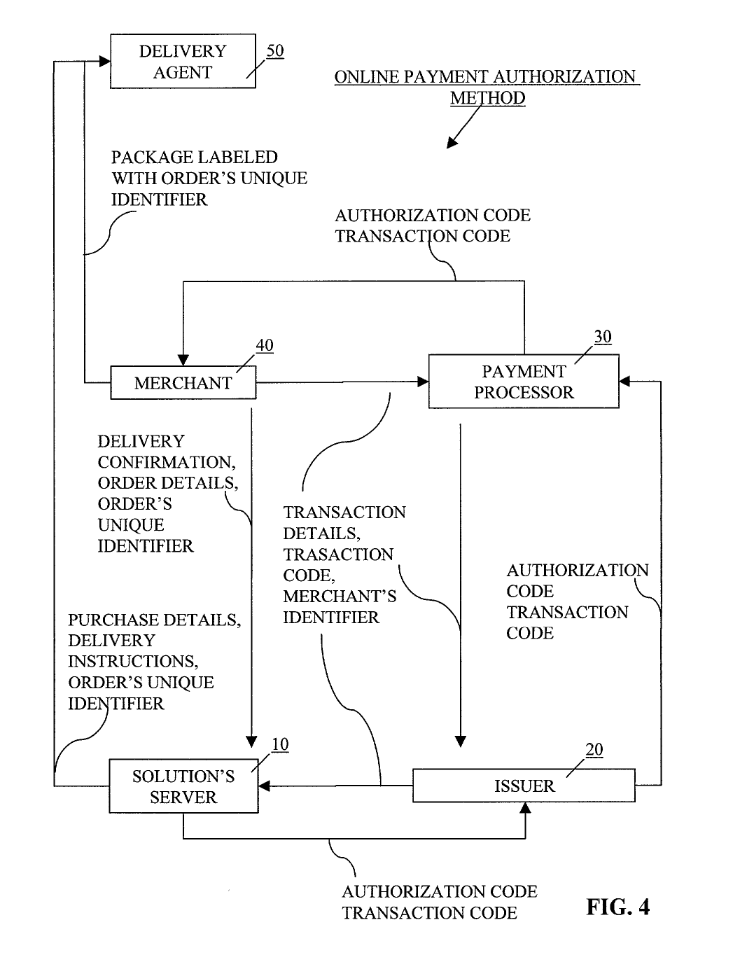

FIG. 4 is a block diagram of the Online Payment Authorization Method consistent with the invention. This implementation is preferably practiced in cases in an embodiment where the Internet is considered and an on-line electronic payment system is also considered. Parties involved in the payment authorization method described in this figure include a Solution's Server 10, an Issuer 20, a Payment Processor 30, a Merchant 40 and a Delivery Agent 50. Issuer 20 issues payment methods to be used only by Solution's Server 10, when Solution's Server 10 places purchases orders on Merchant 40. Those parties are connected through an Authorization Network (private or public) and are communicated during the course of the transaction. For requesting payment for a purchase, Merchant 40 sends a payment authorization request message to the Payment Processor 30; this message includes but it is not limited to Transaction Details, transaction code and Merchant's 40 Identifier. The Merchant 40 puts on hold the purchase until the payment authorization is respond. After processing the transaction, the Payment Processor 30 routes said payment authorization request message to the Issuer 20. After processing the transaction, the Issuer 20 routes said payment authorization request message to the Solution's Server 10. The Solution's Server 10 proceeds as follows: (a) seeks in its database for an order that matches the one that is being requested for authorization and marked as “Payment Authorization to Merchant Pending”; for seeking in the database, the Solution's Server 10 uses the information received from the Issuer 20 and/or other information that may consider appropriate and (b) approves the payment authorization request and marks the purchase as “Payment Authorization to Merchant Done” if it finds a match, or denies the payment authorization request if it does not find a match, either case the Solution Server 10 generates an authorization code for the payment authorization request. The Solution's Server 10 sends back to the Issuer 20 the transaction code and the authorization code. The Issuer 20 sends back to the Payment Processor 30 the transaction code and the authorization code. Based on the Merchant 40 Identifier and the Issuer 20 transaction code and authorization code, the Payment Processor 30 routes back to the Merchant 40 the transaction code and the authorization code. Finally the Merchant 40 based on the authorization code accepts or denies the purchase transaction; in case the payment was approved, the Merchant 40 proceeds as follows: (a) packages the order, (b) generates the Order's Unique Identifier, (c) labels the order's package with said Order's Unique Identifier, (d) sends to the Solution's Server 10 a delivery confirmation message including the order details and said Order's Unique Identifier and (e) delivers the order's package to the Delivery Agent 50. The Solution's Server 10 generates the Delivery Instructions for said order and notifies the Delivery Agent 50 with the order details, Order's Unique Identifier and Delivery Instructions for said order.

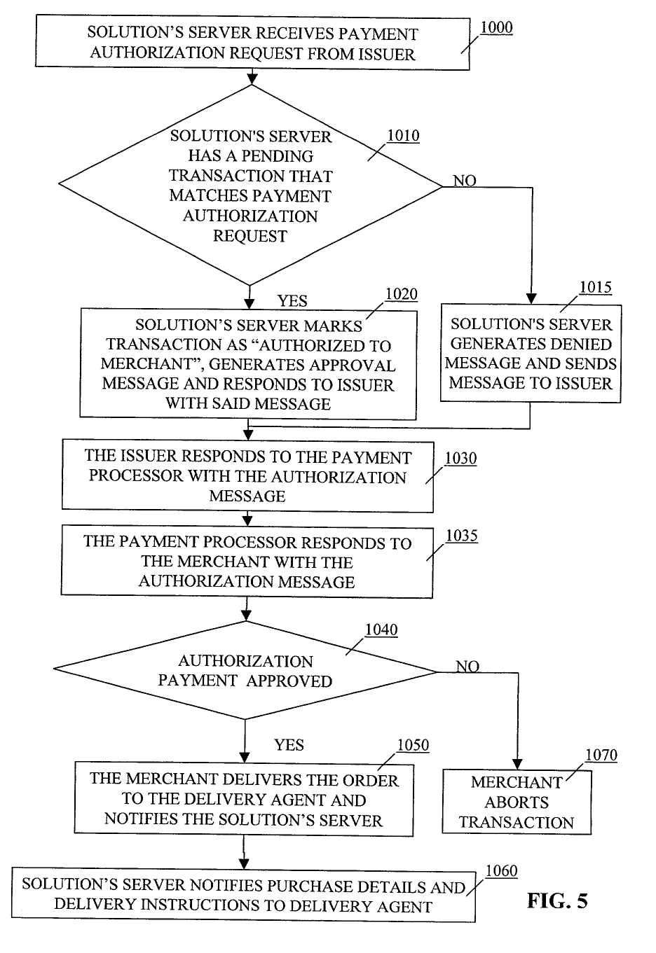

FIG. 5 is a flowchart of the steps involved in an Online Payment Authorization to a specific Merchant 40 in accordance with the implementation in FIG. 4. In this case the transaction is initiated when Merchant 40 sends to Payment Processor 30 the Payment Authorization request for said purchase; the Payment Authorization request includes the payment method identifier, Mercbant's 40 Identifier, purchase amount, transaction code and transaction date; the Payment Processor 30 sends to the Issuer 20 the Payment Authorization request and the Issuer 20 sends to the Solution's Server 10 the Payment Authorization request. The Solution's Server 10 receives the Payment Authorization request from the Issuer 20 (step 1000). The Solution's Server 10 seeks in its database for an Order that matches the one that is being requested for authorization and that is marked as “Payment Authorization to Merchant Pending” (step 1010). In case the Solution's Server 10 does not have a pending transaction that matches the payment authorization request, the Solution's Server 10 generates a denied message and responds to the Issuer 20 with the denied message and the transaction code and this process continues on step 1030 (step 1015). In case the Solution's Server 10 has a pending transaction that matches the Payment Authorization request, the Solution's Server 10 stores relevant information, marks the Order as “Authorized to Merchant”, generates an authorization approval message and responds to the Issuer 20 with said authorization approval message and transaction code and any other information that may be required by the Issuer 20 or Payment Processor 30 or Merchant 40 (step 1020). The Issuer 20 responds to the Payment Processor 30 with the payment authorization message and transaction code received from the Solution's Server 10 (step 1030). Based on the Merchant's 40 Identifier, the Payment Processor 30 responds to the Merchant 40 with the payment authorization message and transaction code received from the Issuer 20 (step 1035). The Merchant 40 receives from the Payment Processor 30 the approval or denied authorization message and evaluates if the payment was approved (step 1040). In case the payment was denied, the Merchant 40 aborts the transaction and notifies the Solution's Server 10 that the payment was not approved (step 1070); if the payment was approved the Merchant 40 proceeds as follows: (a) packages the order, (b) generates the Order's Unique Identifier, (c) labels the order's package with said Order's Unique Identifier, (d) sends to the Solution's Server 10 a delivery confirmation message including the order details and said Order's Unique Identifier and (e) delivers the order's package to the Delivery Agent 50 (step 1050). The Solution's Server 10 generates the Delivery Instructions for the order and notifies the Delivery Agent 50 with the order details, Order's Unique Identifier and Delivery Instructions for said order (step 1060).

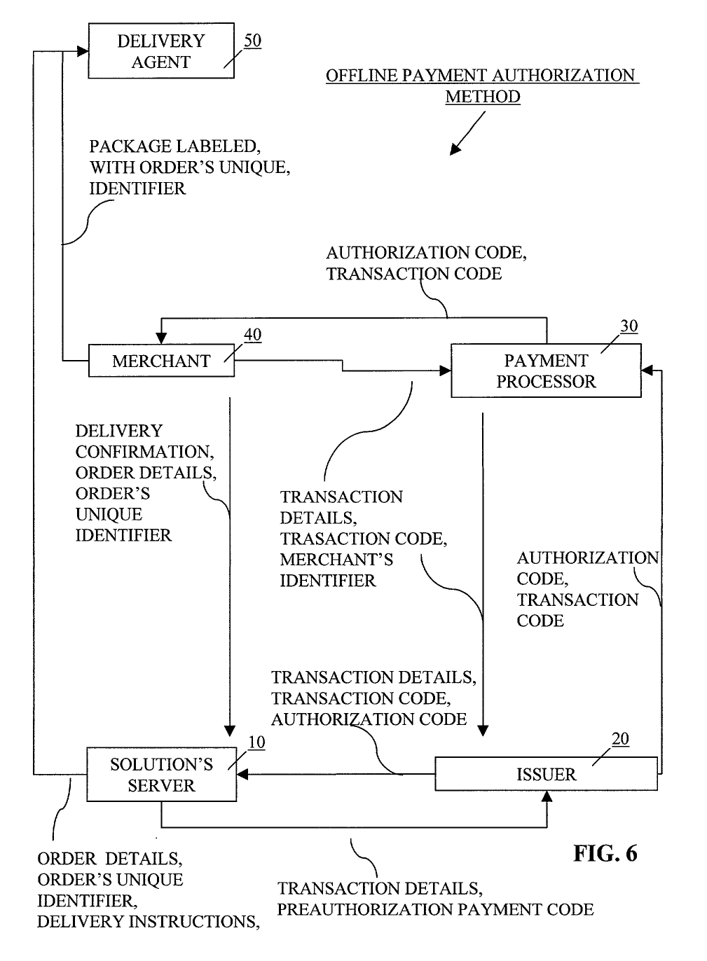

FIG. 6 is a block diagram of the Offline Payment Authorization Method consistent with the invention. This implementation is preferably practiced in cases in an embodiment where the Internet is considered and an off-line electronic payment system is also considered. Parties involved in the payment authorization method described in this figure include an Solution's Server 10, a Issuer 20, a Payment Processor 30, a Merchant 40 and a Delivery Agent 50. Issuer 20 issues payment methods to be used only by Solution's Server 10, when Solution's Server 10 places purchases orders on Merchant 40. Those parties are connected through an Authorization Network (private or public) and are communicated during the course of the transaction. When the Solution's Server 10 sends to the Issuer 20 the Transaction Details and the Pre-authorization Payment Code for a purchase (see step 952 in FIG. 3F), the Issuer 20 associates the Transaction Details with the Pre-authorization Payment Code and stores the information in its database. For requesting payment for said purchase, Merchant 40 sends a payment authorization request message to the Payment Processor 30; this message includes but is not limited to Transaction Details, transaction code and Merchant's 40 Identifier. The Merchant 40 puts on hold the purchase until the payment authorization is respond. After processing the transaction, the Payment Processor 30 routes said payment authorization request message to the Issuer 20. The Issuer 20 proceeds as follows: (a) seeks in its database for an order that matches the one that is being requested for authorization and having a Pre-authorization Payment Code associated; for seeking in the database, the Issuer 20 uses the information received from the Payment Processor 30, Solution's Server 10 and/or other information that may consider appropriate and (b) approves the payment authorization request if it finds a match, or denies the payment authorization request if it does not find a match; either case the Issuer 20 generates an authorization code for the payment authorization request. The Issuer 20 sends back to the Payment Processor 30 the transaction code and the authorization code and sends to the Solution's Server 10 the Transaction Details, transaction code and authorization code. Based on the Merchant 40 Identifier and the Issuer 20 transaction code and authorization code, the Payment Processor 30 routes back to the Merchant 40 the transaction code and the authorization code. Finally the Merchant 40 based on the authorization code accepts or denies the purchase transaction; in case the payment was approved, the Merchant 40 proceeds as follows: (a) packages the order, (b) generates the Order's Unique Identifier, (c) labels the order's package with said Order's Unique Identifier, (d) sends to the Solution's Server 10 a delivery confirmation message including the order details and said Order's Unique Identifier and (e) delivers the order's package to the Delivery Agent 50. The Solution's Server 10 generates the Delivery Instructions for said order and notifies the Delivery Agent 50 with the order details, Order's Unique Identifier and delivery instructions for said order.

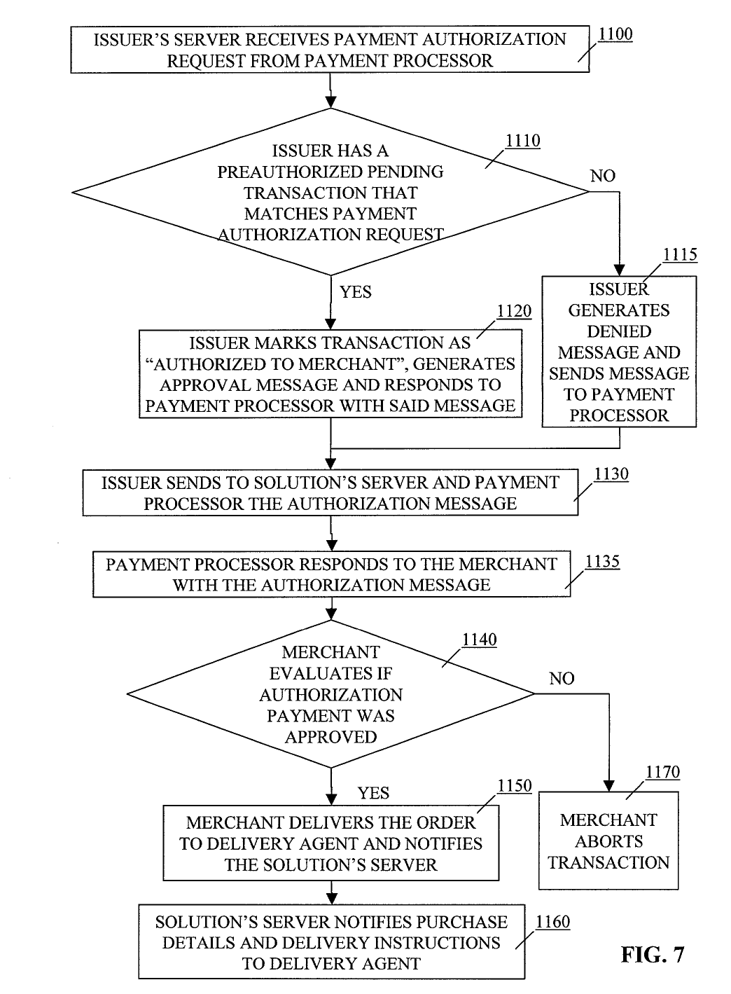

FIG. 7 is a flowchart of the steps involved in an Offline Payment Authorization to a specific Merchant 40 in accordance with the implementation in FIG. 6. In this case the transaction is initiated when Merchant 40 sends to Payment Processor 30 the Payment Authorization request for said purchase; the Payment Authorization request includes payment method identifier, transaction date, Merchant's 40 Identifier, purchase amount, transaction code and transaction date. The Payment Processor 30 sends to the Issuer 20 the Payment Authorization request. The Issuer Server 20 receives the Payment Authorization request from the Payment Processor 30 (step 1100). The Issuer 20 seeks in its data base for an order that matches the one that is being requested for authorization and having a Pre-authorization Payment Code associated; for seeking in the data base the Issuer 20 uses the information received from the Payment Processor 30, Solution's Server 10 and/or other information that may consider appropriate (step 1110); if the Issuer 20 finds a match it marks the transaction as “Authorized to Merchant”, generates an approval payment authorization code and responds with said message to the Payment Processor 30 (step 1120); if the Issuer 20 does not finds a match it generates an denied payment authorization code (step 1115); either case this process continues on step 1130. The Issuer 20 sends back to the Payment Processor 30 the transaction code and the payment authorization code and sends to the Solution's Server 10 the Transaction Details, transaction code and payment authorization code (step 1130). Based on the Merchant 40 Identifier and the Issuer 20 transaction code and authorization code, the Payment Processor 30 routes back to the Merchant 40 the transaction code and the authorization code (step 1135). The Merchant 40 evaluates if the payment has being approved (step 1140); if the payment was denied, the Merchant 40 aborts the transaction (step 1170); if the payment was approved the Merchant 40 proceeds as follows: (a) packages the order, (b) generates the Order's Unique Identifier, (c) labels the order's package with said Order's Unique Identifier, (d) sends to the Solution's Server 10 a delivery confirmation message including the order details and said Order's Unique Identifier and (e) delivers the order's package to the Delivery Agent 50 (step 1150). The Solution's Server 10 generates the Delivery Instructions for the order and notifies the Delivery Agent 50 with the order details, Order's Unique Identifier and Delivery Instructions for said order (step 1160)

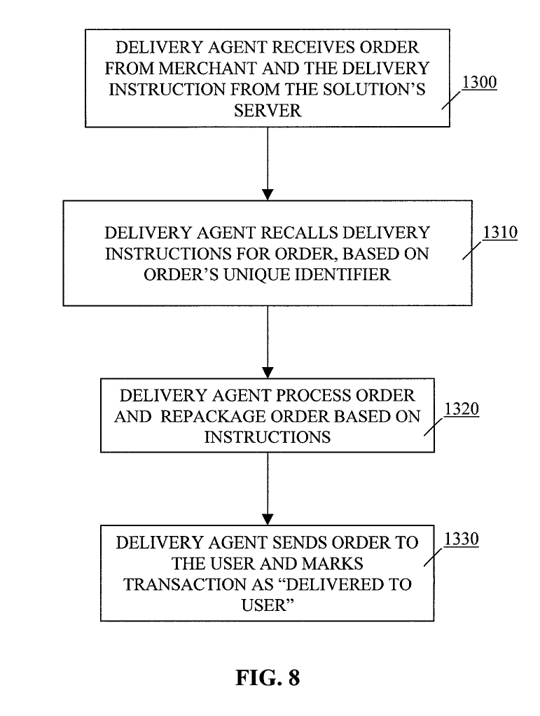

FIG. 8 is a flowchart of the steps involved in the delivery process; splitting the Order Delivery 5 Process from Merchant 40 to Delivery Agent 50 and from Delivery Agent 50 to the User the Solutions safeguards the User's Identity to Merchant 40. The Delivery Agent 50 receives the Order Package from the Merchant 40 and the purchase details, Order's Unique Identifier and Delivery Instructions from the Solution's Server 10 (1300). The Delivery Agent 50 identifies the package based on the Order's Unique Identifier and retrieves the Delivery Instructions notified by the Solution's Server 10 for said Order's Unique Identifier (1310). The Delivery Agent 50 repackages the order and/or consolidates the order package with other order packages based on the Solution's Server 10 delivery instructions (1320). The Delivery Agent 50 delivers the order to the User and updates the tracking status of the order as “Delivered to User” (1330).

While certain novel features of the present invention have been shown and described, it will be understood that various omissions, substitutions and changes in the forms and details of the device illustrated and in its operation can be made by those skilled in the art without departing from the spirit of the invention.

What is claimed is:

1. A method and system for making secure online purchases and payments over a communication network (Network) and the anonymous delivery of said purchases (Solution), the Solution comprising:
a switching communication device for switching communications between entities attached to said Network;
a Merchant server (Merchant) in communication with said Network, said Merchant including an interface for selling at least one item, including but not limited to products and/or services (Products); said Merchant having at least one payment method that can be used by a User for requesting an electronic purchase;
a Client device (Client) in communication with said Network, said Client including a browser software and output device for reviewing said one item for sale, an input device used by the User for initiating a purchase transaction to purchase said one item for sale;
a Solution's Server (Agent) in communication with said Network, said Agent being an intermediary between the Client and the Merchant and being the Client's Agent before the Merchant and a Delivery Agent, said Agent comprising a Solution's Accounts Manager system, said Agent also comprising a Content Manager system that manages the content embedded in electronic messages, said Agent also having a secure and fraud inhibitor method and system that submits the electronic purchase to the Merchant on behalf of the User and processes payments to said Merchant, said Agent also having a system and method for delivering said purchase to the User anonymously;
a Payment Processor used by said Merchant to request payments authorization for said electronic purchase, said Payment Processor having a server (Payment Processor's Server) in communication with said Merchant through said Network or other communication method, including but not limited to Internet, value added networks, point to point telephone lines, fax system and telephone systems, said Payment Processor's Server acting as the Payment Processor for said Merchant for said electronic purchase;
an Issuer that issues payment methods to be used by the Agent for submitting the electronic purchase to the Merchant, said Issuer having a server (Issuer's server) in communication with said Agent and said Payment Processor's Server through the Network or other communication method, including but not limited to Internet, value added networks, point to point telephone lines, fax system and telephone systems, said Issuer's acting as the payment authorization gateway between the Payment Processor and the Agent; and
a Delivery Agent in communication with said Agent through said Network or other communication method, including but not limited to Internet, value added networks, point to point telephone lines, fax system and telephone systems, said Delivery Agent being arranged to deliver said electronic purchase to the User based on the delivery instructions previously notified by the Agent.

2. A Merchant as recited in claim 1 further comprising:
a selling interface;
at least one payment method that may be used by the buyer for paying for the electronic purchase;
a packing process that packs the items of said electronic purchase in an order;
a labeling process that creates and assigns the Order's Unique Identifier to said order;
a delivery method that delivers said order to the buyer; said delivery method being a transportation method for delivering physical orders or an electronic transmission method for delivering electronic orders; and
a Purchase Confirmation Message process that sends a message to the buyer notifying the delivery of said order, the Order Unique Identifier and the Order Details comprising at least one of transaction amount, item, billing address, shipping address and date.

3. A Solution's Account Manager system as recited in claim 1 further comprising:
an Account Registration process being arranged to compute the necessary information required to submit an electronic purchase to said Merchant (Solution's name, Solution's password, Solution's email, Solution's shipping address, Solution's billing address and Solution's payment method, among others), said process also being arranged to create or modify a Solution's Account on said Merchant with all the necessary information required to submit the electronic purchase to said Merchant, said process also being arranged to delete a Solution's Account on said Merchant;
a Replace a Payment Method process being arranged to replace a payment method for a given Solution's Account and given Merchant; and
a Link User to Solution's Account process that associates a User of the Solution with a Solution's Account wherein said association may be in a one (User) to one (Solution's Account) basis or may be in a many (Users) to one (Solution's Account) basis.

4. A Content Manager system as recited in claim 1 further comprising:
a Builder process that constructs an electronic message based on information previously received and/or computed by the Builder process;
a Modifier process that based on predefined rules modifies and/or substitutes all or part of a specific embedded content, said Modifier process also being arranged to communicate said specific embedded content to the Builder process;
a Parser process that, based on predefined rules, searches for specific content embedded in said electronic message and extracts said specific content, said process also being arranged to communicate said specific content to the Modifier and/or Builder processes; and
a Sender process that sends electronic messages over the Network.

5. A secure and fraud inhibitor system and method as recited in claim 1, further comprising:
under the control of an Agent,
a Submit Purchase to Merchant and Make Payments to Merchant process that splits the User's electronic purchase transaction in two processes while managing those processes independently: (i) the Purchase on behalf of the User process and (ii) the Payment Authorization to Merchant process, said Payment Authorization process being arranged to receive payments authorization requests for purchase transactions and authorize or deny said payment authorization requests, said Payment Authorization process being arranged to validate said purchases transaction prior to authorize or deny said payment authorization requests, said purchase validation being arranged to be processed by the Issuer (Offline Payment Authorization) or by the Agent (Online Payment Authorization);
a Create Delivery Instructions process being arranged to compute all the necessary Order's Delivery Instructions needed by the Delivery Agent to repackage an order and to deliver it to the User, said process also being arranged to communicate said Delivery Instructions to the Send Delivery Instructions to Delivery Agent process; and
a Send Delivery Instructions to Delivery Agent process that sends the Order's Unique Identifier, Order's Details and Order's Delivery Instructions for said order to the Delivery Agent, said process being arranged to be based on the Content Manager system for extracting the Order's Unique Identifier and Order's Details from the Merchant's electronic purchase confirmation message.

6. A system for executing the Purchase on behalf of the User process as recited in claim 5, further comprising:
a User's Payment process that identifies the User's electronic purchase and manages the User's payment prior to submitting said electronic purchase to Merchant, said User's Payment process also being arranged to compute and add to the User's payment amount other charges comprising one of service fees, commissions and shipping and handling prior to requesting the User's payment, said User's Payment process also being arranged to offer to the User different payment methods in combination with payments and/or financial plans either supported only by the Solution (proprietary) or supported by the Solution in partnership with other institutions, said User's Payment process also being arranged to generate a User's payment authorization code, said User's Payment process also being arranged to communicate said User's payment authorization code to the Purchase process;
a Data Required by Merchant for Purchase Completion process that completes the Purchase Data that it is required by the Merchant to accept said electronic purchase, said data being arranged to be computed by the Data Required by Merchant for Purchase Completion process and/or retrieved from a Solution's Account for said Merchant and said User, said Data Required by Merchant for Purchase Completion process also being arranged to communicate said data to the Submit Purchase process; and
a Submit Purchase process that based on the user's payment authorization code, submits said electronic purchase to the Merchant using said Purchase Data and said Solution's Account for said Merchant, said Submit Purchase process also being arranged to store the electronic purchase information details in a database and mark said electronic purchase.

7. An Online Payment Authorization system and method for validating a purchase transaction as recited in claim 5, further comprising:
receiving the purchase transaction (either from electronic or traditional retailers) from the Issuer's Server including a transaction code, transaction details and payment method;
validating the purchase transaction, said validation being arranged to use a comparator to compare the data related to the purchase received from the Issuer's Server with those the electronic purchase stored in the Agent;
generating an authorization code based on the purchase validation for said purchase and transmitting said authorization code and transaction code to said Issuer's server; and
marking an electronic purchase based on the authorization code.

8. An Offline Payment Authorization system and method for validating a purchase transaction as recited in claim 5, further comprising:
receiving the payment authorization instructions from the Agent for the electronic purchase submitted by said Agent, the payment authorization instructions comprising a transaction code, transaction details and payment method;
receiving the authorization request from the Payment Processor's Server for a purchase transaction (either from electronic or traditional retailers) including a transaction code, transaction details and payment method;
validating the purchase transaction, said validation being arranged to use a comparator to compare the data related to the purchase transaction received from the Payment Processor's Server with the data related to the electronic purchase received from the Agent;
generating an authorization code based on the purchase validation for said electronic purchase and transmitting said authorization code and transaction code to said Agent;
said Agent marking said electronic purchase based on the authorization code; and
transmitting said authorization code and transaction code to said Payment Processor's Server, whereby said Merchant is authorized to release said item of merchandise to the buyer associated with said purchase transaction; and
marking the electronic purchase based on the authorization code.

9. A Delivery method for executing the Delivery process as recited in claim 1 further comprising:
receiving from the Agent the Order's Unique Identifier and the Order's Delivery Instructions needed by the Delivery Agent to repackage said order and to deliver it to the User;
receiving the order labeled with the Order's Unique Identifier from the Merchant;
validating the Order's Unique Identifier, said validation being arranged to use a comparator to compare the Order's Unique Identifier received from the Agent with the Order's Unique Identifier in the order's label;
a method for repacking and/or consolidating physical orders in accordance with the Order's Delivery Instructions received from the Agent;
a method for forwarding electronic orders in accordance with the Order's Delivery Instructions received from the Agent; and
delivering the order to the User and sending a message to the Agent.

10. The Delivery method for executing the Delivery process as recited in claim 9 further comprising:
a method for tracking the order through the Network.
